(19) United States
(12) Patent Application Publication
(10) Pub. No.: US 2024/0119284 A1
(43) Pub. Date: Apr. 11, 2024

(54) METHOD FOR TRAINING A MACHINE LEARNING MODEL

(71) Applicant: Robert Bosch GmbH, Stuttgart (DE)

(72) Inventors: Joerg Wagner, Renningen (DE); Nils Oliver Ferguson, Weil Der Stadt-Merklingen (DE); Stephan Scheiderer, Leonberg (DE); Yu Yao, Herzogenrath (DE); Avinash Kumar, Bangalore (IN); Barbara Rakitsch, Stuttgart (DE); Eitan Kosman, Haifa (IL); Gonca Guersun, Stuttgart (DE); Michael Herman, Sindelfingen (DE)

(21) Appl. No.: 18/476,076

(22) Filed: Sep. 27, 2023

(30) Foreign Application Priority Data
Oct. 7, 2022 (DE) 10 2022 210 639.3

(51) Int. Cl. G06N 3/08; G06N 3/047; G06N 3/049

(52) U.S. Cl. CPC G06N 3/08; G06N 3/047; G06N 3/049

(57) ABSTRACT

A method for training a machine learning model. The method includes: determining a plurality of training sequences of training-input data elements, wherein for each training sequence each training-input data element contains sensor data for a time point from a time period assigned to the training sequence in which a prespecified event takes place at least once at one or more respective event time points; determining, for each training-input data element, the temporal distance between the time point for which the training-input data element contains sensor data and one of the one or more respective event time points; and training the machine learning model depending on the determined temporal distances.

### CROSS REFERENCE

The present application claims the benefit under 35 U.S.C. § 119 of German Patent Application No. DE 10 2022 210 639.3 filed on Oct. 7, 2022, which is expressly incorporated herein by reference in its entirety.

### FIELD

The present invention relates to a method for training a machine learning model.

### BACKGROUND INFORMATION

Machine learning models such as neural networks are typically trained on the basis of a deviation between an output and a target output (e.g., a ground truth in the form of labels). A plurality of training-input data elements is fed to the machine learning model in question and a total loss is formed from the individual losses (per training-input data element). The importance of training-input data elements for the training can vary greatly: i.e., the machine learning model is, for example, intended to be particularly sensitized to features which are reflected only in a few of the training-input data elements.

For this reason, approaches to the training of machine learning models are desirable in which the focus of training is on training-input data elements that are of great importance for training for a particular task.

### SUMMARY

According to various embodiments of the present invention, a method for training a machine learning model is provided, comprising: determining a plurality of training sequences of training-input data elements, wherein for each training sequence each training-input data element contains sensor data for a time point from a time period assigned to the training sequence in which a prespecified event takes place at least once at one or more respective event time points; determining, for each training-input data element, the temporal distance between the time point for which the training-input data element contains sensor data and one of the one or more respective event time points; and training the machine learning model on the basis of the determined temporal distances.

The method described above makes it possible to focus the training procedure on specific important time periods (i.e., for example, critical training-input data elements) for which the training data contain sensor data. As a result, the performance (e.g. prediction accuracy) of the trained machine learning model and the data efficiency of training can be increased. This can also be achieved even when the importance of the training-input data elements does not correlate with the frequency with which their labels occur. The output of the machine learning model can also be continuous (i.e., it can be trained for a classification task or even for a regression task).

Various exemplary embodiments of the present invention are specified below.

Exemplary embodiment 1 is a method for training a machine learning model, as described above.

Exemplary embodiment 2 is a method according to exemplary embodiment 1, wherein the training comprises: determining, for each training-input data element, a target output of the machine learning model; supplying the training-input data elements to the machine learning model; determining a loss which for each training-input data element comprises a deviation between an output of the machine learning model for the training-input data element and the target output determined for the training-input data element, wherein, for each training-input data element, the deviation in the loss is weighted with a weighting factor which depends on the temporal distance determined for the training-input data element; and training the neural network to reduce the loss.

This enables an effective consideration of the importance of training-input data elements for training the machine learning model with regard to the detection of certain events.

Exemplary embodiment 3 is a method according to exemplary embodiment 2, wherein the lower the value of the temporal distance determined for the training-input data element, the greater the weighting factor will be.

This is based on the assumption that sensor data which lie closer to an event are more relevant for the detection of the event than are sensor data which lie further away (in terms of time).

Exemplary embodiment 4 is a method according to exemplary embodiment 2 or 3, wherein the weighting factor depends on whether the time point for which the training-input data element contains sensor data lies before or after the one of the one or more respective event time points.

The different importance of a training-input data element for the training can thus be taken into account, whether it contains sensor data before or after an event (for example represents a new situation).

Exemplary embodiment 5 is a method according to any one of exemplary embodiments 1 to 4, wherein training-input data elements are selected from the training-input data elements, wherein for each training-input data element the probability of it being selected is dependent on the temporal distance determined for the training-input data element, and the machine learning model is trained by means of the selected training-input data elements.

This is a further possibility for effectively taking into consideration the importance of training-input data elements for training the machine learning model with regard to the detection of certain events. It can be used in combination with the adjustment of weighting according to exemplary embodiment 2.

For example, the training-input data elements that are not selected are not used for training. This can increase data efficiency. The selected training-input data elements may also be divided into training-input data elements for training, for validation and for testing.

Exemplary embodiment 6 is a method according to exemplary embodiment 5, wherein the lower the value of the temporal distance determined for the training-input data element, the greater the probability will be.

As above, this is based on the assumption that sensor data which lie closer to an event are more relevant for the detection of the event than are sensor data which lie further away (in terms of time).

Exemplary embodiment 7 is a method according to exemplary embodiment 5 or 6, wherein the weighting factor depends on whether the time point for which the training-input data element contains sensor data lies before or after the one of the one or more respective event time points.

Similarly to the case of adaptive weighting described above, the differing importance of a training-input data element for the training can thus be taken into account, whether it contains sensor data before or after an event.

Exemplary embodiment 8 is a method according to any one of exemplary embodiments 1 to 7, wherein for a training sequence to which a time period is assigned in which the prespecified event occurs several times, the temporal distance of a training-input data element of the training sequence between the time point for which the training-input data element contains sensor data and the event time point closest to the time point for which the training-input data element contains sensor data is determined.

In a time period which corresponds to a training sequence (i.e., with which the training sequence is associated (or which is assigned thereto) in the sense that the training sequence contains sensor data for the time period), an event can thus occur several times and the temporal distance then takes into consideration the closest occurrence. In this case, a plurality of different events can also be specified and respective temporal distances can be taken into consideration (i.e., a weight can also depend on temporal distances to different events).

Exemplary embodiment 9 is a training device which is configured to carry out a method according to any one of exemplary embodiments 1 to 8.

Exemplary embodiment 10 is a computer program comprising commands which, when executed by a processor, cause the processor to carry out a method according to any one of exemplary embodiments 1 to 8.

Exemplary embodiment 11 is a computer-readable medium that stores commands which, when executed by a processor, cause the processor to carry out a method according to any one of exemplary embodiments 1 to 8.

In the figures, similar reference signs generally refer to the same parts throughout the various views. The figures are not necessarily true to scale, with emphasis instead generally being placed on the representation of the principles of the present invention. In the following description, various aspects are described with reference to the figures.

### BRIEF DESCRIPTION OF THE DRAWINGS

FIG. 1 shows a vehicle, according to an example embodiment of the present invention.

FIG. 2 illustrates the training of a neural network, according to an example embodiment of the present invention.

FIG. 3 shows an example in which a time series for the training contains sensor data about a path traveled by a vehicle, according to the present invention.

FIG. 4 shows an example in which a time series for the training contains audio levels of a microphone, according to the present invention.

FIG. 5 shows a flowchart illustrating a method for training a machine learning model according to an example embodiment of the present invention.

### DETAILED DESCRIPTION OF EXAMPLE EMBODIMENTS

The following detailed description relates to the figures, which show, by way of explanation, specific details and aspects of this disclosure in which the present invention can be executed.

Other aspects may be used and structural, logical, and electrical changes may be performed without departing from the scope of protection of the present invention. The various aspects of this disclosure are not necessarily mutually exclusive, since some aspects of this disclosure may be combined with one or more other aspects of this disclosure to form new aspects.

Various examples are described in more detail below.

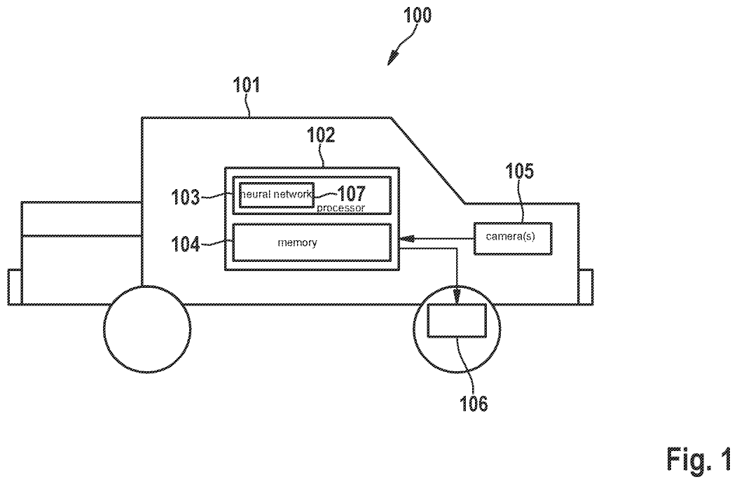

FIG. 1 shows a (e.g. autonomous) vehicle 101.

In the example of FIG. 1, the vehicle 101, for example a passenger car or truck, is provided with a vehicle control device 102.

The vehicle control device 102 comprises data-processing components, e.g. a processor (e.g. a CPU (central unit)) 103 and a memory 104 for storing control software, according to which the vehicle control device 102 operates, and data processed by the processor 103.

For example, the stored control software (computer program) comprises instructions which, when the processor executes them, cause the processor 103 to implement a neural network 107.

The data stored in the memory 104 may include, for example, image data captured by one or more cameras 105. The one or more cameras 105 may, for example, capture one or more grayscale or color photographs of the surroundings of the vehicle 101. On the basis of the image data, the neural network 107 can then determine, for example, in which lane the vehicle 101 is located. Another possibility is, for example, that the vehicle control device 102 contains position information (i.e., for example, as x-y coordinates in a relevant coordinate system, for example from GPS measurements) and the neural network 107 determines from the position information in which lane said vehicle is located.

The vehicle 101 may then be controlled by the vehicle control device 102 according to the output of the neural network 107. For example, a lane keeping assistant can help to keep the vehicle in the lane for which the neural network 107 has detected that the vehicle 101 is located therein.

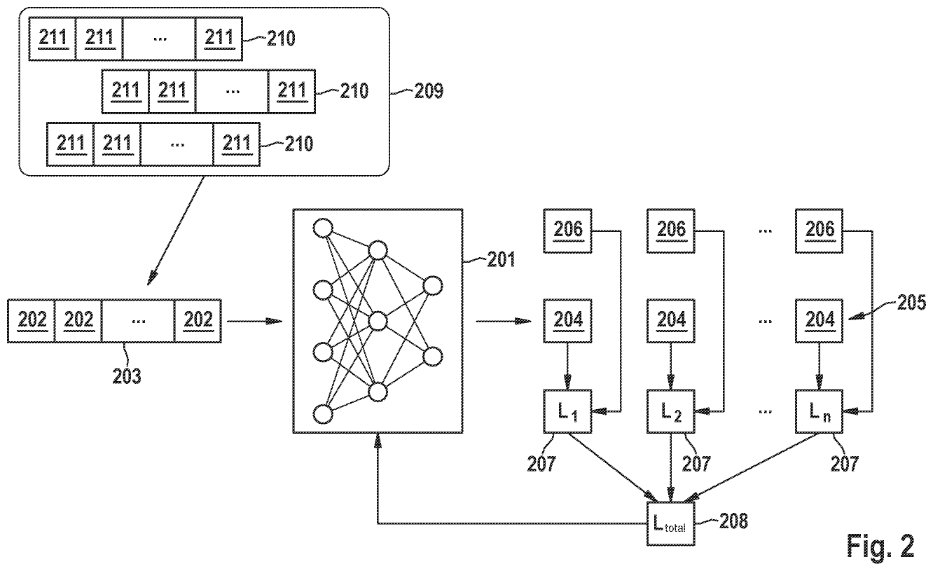

FIG. 2 illustrates the training of a neural network 201.

Training-input data elements 202 of an (input) sequence 203 of training-input data elements (i.e., a training sequence of training-input data elements) are successively fed to the neural network 201. According to the above example, a training-input data element is, for example, a camera image or a pair of x-y coordinates.

For each training-input data element 202, the neural network 201 generates a relevant output (i.e., an output data element) 204, i.e., upon input of the input sequence 203 corresponding to an (output) sequence 205 of output data elements.

For each training-input data element 202, there is also a relevant target output 206. In the case of supervised learning, these can be prespecified labels, but can also be generated or present in self-supervised learning. For example, during training of an autoencoder, the target output is identical to the input data element. In general, the target output 206 is an output to which the output 204 of the neural network 201 should be as close as possible.

From a deviation of the output 204 of the neural network from the associated target output 206 (i.e., for a specific training-input data element 202, a (single) loss 207 can be calculated for this training-input data element 202. This can be the difference, but also a quadratic difference, etc.

Combining the individual losses 207 provides a total loss 208. The parameters (i.e., weights) of the neural network 201 are then adjusted (typically by means of back-propagation) in order to reduce the total loss 208. This is typically carried out in so-called batches, i.e., the sequence 203 is a batch of training-input data elements 202. All batches used for training together form the training dataset.

During training of a neural network 201 (or generally of a machine learning model in a similar manner), the individual losses 207 can be weighted differently in the total loss 208 in order to take into consideration the relative importance of the training-input data elements in comparison with other training-input data elements in the training dataset. The magnitude of the weighting of the individual loss 207 of a training-input data element 202 is, for example, obtained from the frequency of the occurrence of the label of the training-input data element 202 in the training dataset. For example, labels that are under-represented in the training dataset are given a higher weighting than identifiers that are over-represented.

However, the approach described above of weighting individual losses depending on the frequency of their labels may not capture the actual importance that individual training data elements have for training the neural network for a particular task. For this reason, according to various embodiments, a single loss 208 of a training-input data element 202 is not (or at least not only) weighted depending on its label, but is provided with a weighting factor according to the temporal distance between a time point for which the training-input data element 202 contains sensor data and the time point of the occurrence of a prespecified event, which weighting factor is reflected in the training-input data elements 202 which, for example, belong to a time series.

It is assumed for the sake of simplicity that the input sequence 203 corresponds to a time series from a pool 209 of time series (i.e., training sequences) 210 (each with a plurality of (training-input) data elements 211). Accordingly, the total loss 208 in this case is the loss for training-input data elements 202 from this time series. (It should be noted that this is only a simple example to explain the following: a batch may include several of the time series 210, wherein the total loss 208 is then calculated for each time series and these total losses 208 are combined to form a total loss for the batch and the neural network 201 is adjusted in order to reduce the total loss for the batch).

Each training-input data element 202 is then therefore an element of a time series, i.e., contains sensor data for a specific time point of a sequence of time points from a time period (for which the time series contains sensor data). It is now further assumed that in the time period a prespecified event (at one or more event time points) takes place at least once, i.e., the sensor data correspond to (at least) one occurrence of the predetermined event in the time period or reflect this (at least one) occurrence.

For example, each training-input data element contains sensor data of a time point (or also of a relevant segment or relevant time window that is associated with a time point (e.g., its starting or middle time point)) of an acquisition of sensor data such as, for example, an audio recording or an image or video recording (so that each training-input data element then contains one or more frames). For the training of the neural network 201, a corresponding training device (e.g., which can be the vehicle control device 102 but also a separate training device from which the trained neural network is then transferred into the vehicle control device 102) uses the definition of one or more events or a procedure in order to determine the one or more event time points per time series 210. In addition, it is assumed that each training-input data element 202 is associated with a time point (namely the one for which it contains sensor data, which may also correspond to a specific range around the time point (i.e., the sensor data for which it contains sensor data can also be sensor data from a specific range around the time point), e.g., a segment or time window), so that the training device for the training-input data element 202 can calculate a temporal distance dt between the time point with which it is associated and the event time point (e.g., the closest event time point in the case that the event occurs multiple times in the time period for which the time series contains sensor data). The training device then maps the temporal distance onto a weight w(dt), with which it weights the individual loss 207 when calculating the total loss 208, e.g. according to

Lₜₒₜₐₗ=L₁*w(dt₁)+L₂*w(dt₂)+ . . . Ln*w(dtₙ).

where L₁ is the individual loss 207 of the i-th training-input data element 202 of the time series 203, dt₁ is its temporal distance (to a relevant event time point) and Lₜₒₜₐₗ is the total loss 208.

The event time points are specified for example for the training time series 210 (e.g. by human or automatic annotation). An event is, for example, an object leaving the field of view of a camera or a vehicle changing lanes.

For each time series 210 (or at least those used for the training), the training device determines the event time points, calculates the temporal distance (e. g., at the closest event time point of the time series) for each training-input data element, maps the temporal distance onto a weight by means of the function w(dt) and uses the weight during training of the neural network 201 in order to weight the contribution of the training-input data element (i.e., the individual loss 207) to the total loss 208.

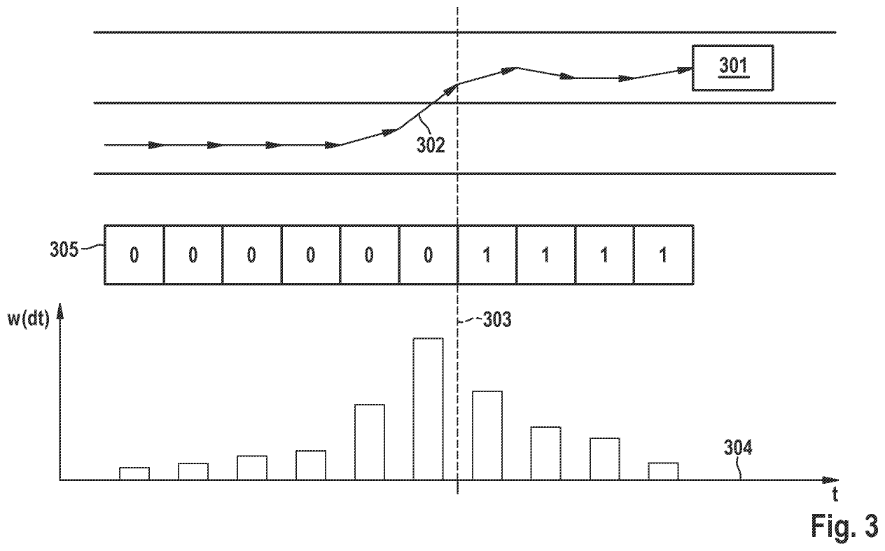

FIG. 3 shows an example in which the time series contains sensor data about a path 302 traveled by a vehicle 301 (e.g. x-y positions or camera images from the perspective of the vehicle 301). The event at an event time point 303 (marked on a time axis 304) is a lane change. The labels 305 of the training-input data elements are 0 before the lane change and 1 after the lane change (i.e., the task for which the neural network 201 is to be trained is the detection of a lane change). As shown along the time axis 304, the weights w(dt) are calculated so that the lower the value of the temporal distance dt, the greater the weights will be (the weights may also be scaled differently before and after the event time point.

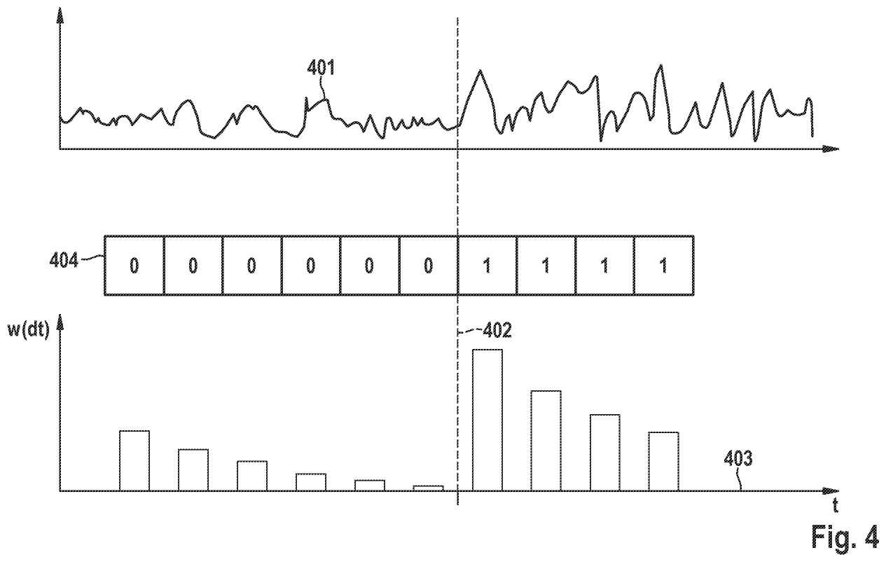

FIG. 4 shows an example in which the time series contains audio levels 401 of a microphone. The event at an event time point 402 (marked on a time axis 403) is a user starting to speak (i.e., the transition from noise to speech). The labels 404 of the training-input data elements are 0 before the start of speaking and 1 after the start of speaking (i.e., the task for which the neural network 201 is to be trained is speech detection, for example in order to automatically cancel the user's muting). As shown along the time axis 403, the weights w(dt) are calculated such that before the event, the lower the value of the temporal distance dt, the smaller the weights will be, and after the event, the lower the value of the temporal distance dt, the greater the weights will be. In this example, the function w(dt) therefore takes into account the sign of dt (e.g. the temporal distance dt will be negative if the time point that is associated with the training-input data element lies before the event time point 402, and positive if the time point associated with the training-input data element lies after the event time point 402). The result is that the last noise samples have a low weighting and the first voice samples have a high weighting.

In the example above, the training of the neural network 201, as described, depends on the temporal distances in that the individual losses 207 are weighted depending on the temporal distances.

Alternatively (but also additionally), the training of the neural network 201 can, however, also depend on the temporal distances in that the training-input data elements 202 are selected depending on the temporal distances. For example, the training-input data elements 202 are sampled from the pool 209 of time series 210 (each with multiple data elements 211) and the probability that a data element 211 is selected for training the neural network 201, i.e., as a training-input data element 202, depends on the temporal distance of the data element 211 from the relevant event (i.e., from the time point at which the prespecified event occurs for the relevant time series 211). In other words, instead of a weighting of the individual loss depending on the temporal distance (e. g., a higher weighting when it is closer to the time point of the event), the probability of a data element being sampled as a training-input data element depends on the temporal distance (e.g. a greater probability if it is closer to the time point of the event.

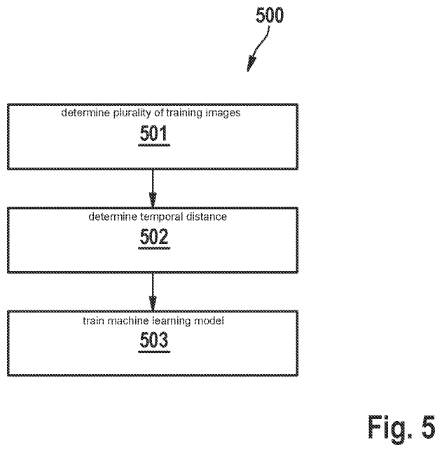

In summary, according to various embodiments, a method is provided as shown in FIG. 5.

FIG. 5 shows a flowchart 500 illustrating a method for training a machine learning model according to an embodiment.

In 501, a plurality of training sequences (i.e., training time series) of training-input data elements are determined, wherein for each training sequence each training-input data element contains sensor data of a time point from a time period assigned to the training sequence in which a prespecified event takes place at least once at one or more respective event time points.

In 502, for each training-input data element, the temporal distance between the time point for which the training-input data element contains sensor data and one of the one or more respective event time points is determined.

In 503, the machine learning model is trained depending on the determined temporal distances.

It should be noted that 502 and 503 do not need to be performed strictly one after the other, i.e., training steps and calculation steps for the temporal distance can alternate. Even with 501 these steps can alternate in some cases.

The method of FIG. 5 may be performed by one or more computers with one or more data processing units. The term “data processing unit” may be understood as any type of entity that enables processing of data or signals. The data or signals can be treated, for example, according to at least one (i.e. one or more than one) special function which is performed by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way to implement the respective functions described in more detail herein may also be understood as a data processing unit or logic circuitry. One or more of the method steps described in detail here can be executed (e.g. implemented) by a data processing unit by one or more special functions that are performed by the data processing unit.

The method is therefore in particular computer-implemented according to various embodiments.

After the training, the machine learning model can be applied to sensor data which are determined by at least one sensor. The output of the machine learning model thus provides a result regarding a physical state of the surroundings of the at least one sensor and/or of the at least one sensor, or the method may comprise using the output of the trained machine learning model, which it provides in response to an input of sensor data, as such as result.

The result regarding the physical state can in particular contain information as to whether the prespecified event has occurred (e.g., a speaker has started to speak or a lane change has taken place). In other words, the result can characterize via the physical state the occurrence of the prespecified event.

In other words, the method can comprise deriving or predicting the physical state of an existing real object on the basis of measurements of physical properties (i.e., sensor data relating to the object) by means of the trained machine learning model (i.e., its output in response to the sensor data).

For example, the machine learning model after the training is used for generating a control signal for a robot device by supplying it with sensor data relating to the robot device and/or its surroundings. The term “robot device” may be understood to refer to any technical system (comprising a mechanical part whose movement is controlled), such as a computer-controlled machine, a vehicle, a household appliance, a power tool, a manufacturing machine, a personal assistant or an access control system.

Various embodiments can receive and use time series of sensor data from various sensors, such as video, radar, lidar, ultrasound, motion, heat imaging, etc. Sensor data can be measured or also simulated for time periods (corresponding to one or more event time points and one or more prespecified events).

Although specific embodiments have been depicted and described herein, a person skilled in the art will recognize that the specific embodiments shown and described may be replaced with a variety of alternative and/or equivalent implementations without departing from the scope of protection of the present invention. This application is intended to cover any adaptations or variations of the specific embodiments discussed herein.

What is claimed is:

1. A method for training a machine learning model, comprising:
determining a plurality of training sequences of training-input data elements, wherein for each training sequence of the training sequences, each of the training-input data elements contains sensor data for a time point from a time period assigned to the training sequence in which a prespecified event takes at least once at one or more respective event time points;
determining, for each training-input data element, the temporal distance between the time point for which the training-input data element contains sensor data and one of the one or more respective event time points; and
training the machine learning model depending on the determined temporal distances.

2. The method according to claim 1, wherein the training includes:
determining, for each training-input data element, a target output of the machine learning model;
supplying the training-input data elements to the machine learning model, and determining a loss which, for each training-input data element, includes a deviation between an output of the machine learning model for the training-input data element and the target output determined for the training-input data element, wherein, for each training-input data element, the deviation in the loss is weighted with a weighting factor which depends on the temporal distance determined for the training-input data element; and
training the neural network to reduce the loss.

3. The method according to claim 2, wherein the lower the value of the temporal distance determined for the training-input data element, the greater the weighting factor is.

4. The method according to claim 2, wherein the weighting factor depends on whether the time point for which the training-input data element contains sensor data lies before or after the one of the one or more respective event time points.

5. The method according to claim 1, wherein training-input data elements are selected from the training-input data elements, wherein for each training-input data element, a probability of the training-input data element being selected is dependent on the temporal distance determined for the training-input data element, and the machine learning model is trained using the selected training-input data elements.

6. The method according to claim 5, wherein the lower the value of the temporal distance determined for the training-input data element, the greater the probability is.

7. The method according to claim 5, wherein the weighting factor depends on whether the time point for which the training-input data element contains sensor data lies before or after the one of the one or more respective event time points.

8. The method according to claim 1, wherein for a training sequence to which a time period is assigned in which the predetermined event occurs several times, the temporal distance of a training-input data element of the training sequence between the time point for which the training-input data element contains sensor data and the event time point closest to the time point for which the training-input data element contains sensor data is determined.

9. A training device configured to train a machine learning model, the training device configured to:
determine a plurality of training sequences of training-input data elements, wherein for each training sequence of the training sequences, each of the training-input data elements contains sensor data for a time point from a time period assigned to the training sequence in which a prespecified event takes at least once at one or more respective event time points;
determine, for each training-input data element, the temporal distance between the time point for which the training-input data element contains sensor data and one of the one or more respective event time points; and
train the machine learning model depending on the determined temporal distances.

10. A non-transitory computer-readable medium on which are stored commands for training a machine learning model, the commands, when executed by a processor, causing the processor to perform the following steps:
determining a plurality of training sequences of training-input data elements, wherein for each training sequence of the training sequences, each of the training-input data elements contains sensor data for a time point from a time period assigned to the training sequence in which a prespecified event takes at least once at one or more respective event time points;
determining, for each training-input data element, the temporal distance between the time point for which the training-input data element contains sensor data and one of the one or more respective event time points; and
training the machine learning model depending on the determined temporal distances.
